(19) United States
(12) Patent Application Publication
(10) Pub. No.: US 2005/0017091 A1
(43) Pub. Date: Jan. 27, 2005

(54) Abrasive water-jet cutting nozzle having a vented water-jet pathway

(75) Inventors: John H. Olsen, Vashon, WA (US); Jiyue Zeng, Bellevue, WA (US); Scott D. Veenhuizen, Covington, WA (US); Brian K. Guglielmetti, Kent, WA (US)

Correspondence Address: GRAYBEAL JACKSON HALEY LLP;Attention: Frederick A. Kaseburg, Suite 350, 155 - 108th Avenue NE, Bellevue, WA, 98004-5973, US

(73) Assignee: Omax Corporation

(21) Appl. No.: 10/625,338

(22) Filed: Jul. 22, 2003

(51) Int. Cl. B05B 7/10

(52) U.S. Cl. 239/400; 239/416.1

(57) ABSTRACT

A vented abrasive water-jet nozzle including a nozzle body having an abrasive-material mixing cavity, a receiving portion having receiving surface that receives a vented water-jet forming assembly, and an airflow restriction orifice between the receiving portion and the abrasive-material mixing cavity defining a water-jet pathway. The nozzle also includes an air-vent inlet port, and an air-vent pathway coupled between the air-inlet port and the waterjet pathway. A vented water-jet forming assembly includes a body having two spaced-apart surfaces, the first surface including a portion that receives a high-pressure water source, and the second surface including a portion that engages a receiving surface of an abrasive water-jet nozzle, and a jewel having a water-jet forming orifice carried on the receiving portion of the first surface. The assembly also includes a bore, and an air-vent pathway, the bore coupling the orifice and the air-vent pathway.

### BACKGROUND

The use of high-velocity, abrasive-laden liquid jets to precisely cut a variety of materials is well known. Briefly, a high-velocity liquid jet is first formed by compressing the liquid to an operating pressure of between approximately 35,000 and 60,000 psi, and forcing the compressed liquid through an orifice having a diameter approximating 0.007-0.015 inches. The resulting highly coherent jet is discharged from the orifice at a velocity that approaches or exceeds the speed of sound. The liquid most frequently used to form the jet is water, and the high-velocity jet described hereinafter may accordingly be identified as a “water-jet,” or a “waterjet.” Those skilled in the art will recognize that numerous liquids other than water can be used without departing from the scope of the invention, and the recitation of the jet as comprising water should not be interpreted as a limitation. For example, fluids other than water can also be employed to cut materials that cannot be in contact with water. The customary term for this process is “water-jet cutting,” and this document will refer to “water-jet cutting” and the like not intending to exclude cutting by jets of fluid other than water.

To enhance the cutting power of the water-jet, abrasive,materials are added to the water-jet stream to produce an abrasive-laden water-jet, typically called an “abrasive water-jet” or an “abrasive jet.” The abrasive water-jet is used to cut a wide variety of materials from exceptionally hard materials (such as tool steel, aluminum, cast-iron armor plate, certain ceramics and bullet-proof glass) to soft materials (such as lead). Abrasive water-jets can accomplish the cutting of intricate slots, through cuts and curves cut in metals, glass, stone, composites, and similar materials. For cutting metals, abrasive grit from a hopper at ambient air pressure is added to the water-jet stream prior to the impact of the jet on the workpiece. Typical abrasive materials include garnet, silica, and aluminum oxide having grit sizes ranging between approximately #36 and approximately #220.

The material forming the water-jet is an orifice defined in a hard jewel held in a mount. The jewel is typically a sapphire, ruby or diamond. To produce an abrasive-laden water-jet, the water-jet passes through a “mixing region” in a nozzle wherein a quantity of abrasive is entrained into the water-jet by the low-pressure region that surrounds the flowing liquid in accordance with the Venturi effect. The abrasive, which is under atmospheric pressure in an external hopper, is drawn into the mixing region by the lower pressure region through a conduit that communicates with abrasive contained in a hopper. The resulting abrasive-laden water-jet is then discharged against a workpiece through a nozzle tip that is supported closely adjacent to the workpiece.

The typical technique for cutting by abrasive water-jets is to mount the piece to be cut (hereinafter “workpiece”) in a suitable jig, or other means for securing the workpiece into position. The abrasive water-jet, often traveling at more than the speed of sound, is typically directed onto the workpiece to accomplish the desired cutting, generally under computer or robotic control. The cutting power is typically generated by means of a high-pressure pump connected to the cutting head through high-pressure tubing, hose, piping, accumulators, and filters. It is not necessary to keep the workpiece stationary and to manipulate the water-jet cutting tool. The workpiece can be manipulated under a stationary cutting jet, or both the water-jet and the workpiece can be manipulated to facilitate cutting.

Wear of the abrasive water-jet-forming components is a particular concern, especially wear caused by the abrasive. As the water-jet-forming orifice, mixing region, and abrasive water-jet nozzle become worn, cutting efficiency decreases dramatically. The result is that the cut surface quality is degraded. The waterjet forming orifice in the hard jewel is subject to a phenomenon where some abrasive particles travel upstream from the mixing cavity during the cutting process and abrade the jewel mount, the jewel, and the orifice. Some abrasive particles even migrate upstream of the jewel orifice. The upstream abrasive particle travel abrades and wears away these critical components, especially the orifice that defines the water-jet, thus, increasing maintenance and downtime costs of using an abrasive waterjet. A need was previously recognized for limiting upstream travel of the abrasive particles. However, previous attempts at inhibiting abrasive material upstream travel were not successful. One unsuccessful attempt included providing a small, ambient air pathway into a portion of a water-jet pathway between the orifice and the mixing chamber. In the unsuccessful attempt, the cross-sectional area of the ambient air pathway was approximately equal to a cross-sectional area of the water-jet pathway.

In view of the foregoing, there is a need in the art for a new and improved apparatus and method for limiting upstream travel of the abrasive products and the resulting abrasion and wear of the jewel and jewel mount. The present invention is directed to such a device, system, and method.

### SUMMARY

An embodiment of the present invention provides a device for abrasive waterjet cutting having a vented water-jet pathway to reduce abrasion of a jewel orifice by the abrasive. A vented abrasive water-jet nozzle includes a nozzle body having an abrasive-material mixing cavity, a receiving portion having a receiving surface that receives a water-jet forming orifice assembly, and an airflow restriction orifice between the receiving portion and the abrasive-material mixing cavity defining a water-jet pathway. The nozzle also includes an air-vent inlet port, and an air-vent pathway coupled between the air-inlet port and the water-jet pathway. The airflow restriction orifice has a first minimum cross-section area and the air-vent pathway has a second minimum cross-section area, the second cross-section area being at least twice the first cross-section area. The second cross-section area may be at least four times the first cross-section area. The water-jet pathway may further include the nozzle body airflow restriction orifice and an orifice assembly bore of the orifice assembly when the orifice assembly is received in the nozzle body. The water-jet pathway may include an air gap between the orifice assembly bore and the nozzle body airflow restriction orifice. The air-vent pathway may be further coupled between the air-inlet port and the air gap. The air gap may be defined when the orifice assembly is received in the nozzle body, where the orifice assembly includes the air gap in the water-jet pathway. The water-jet pathway may include an air gap in the airflow restriction orifice, and the air-vent pathway may be further coupled between the air-inlet port and the air gap. The air-vent inlet port may be configured for venting with an ambient atmosphere.

Another embodiment of the present invention provides a vented water-jet orifice assembly. The assembly includes a body having an engaging portion that engages a receiving surface of an abrasive water-jet nozzle, a water-jet forming orifice, and a bore. The assembly also includes an air-vent pathway, with the bore coupling the orifice and the air-vent pathway. The water-jet forming orifice may include a jewel having an orifice. The body may include two separated surfaces, the orifice being defined in one surface and the engaging portion being defined in another surface. The air-vent pathway may include a slot in the body, and the slot may define a cavity about the bore. The assembly, when engaged with a receiving surface of an abrasive water-jet nozzle, may cooperatively define with the nozzle, an air-vent pathway between an air-inlet port of the nozzle and a water-jet pathway. The assembly, when engaged with a receiving surface of an abrasive water-jet nozzle, may cooperatively define an air gap between the orifice assembly bore and a nozzle body airflow restriction orifice of the nozzle, the air gap being in air communication with the air-vent pathway.

A further embodiment of the present invention provides a vented water-jet orifice assembly. The assembly includes a body having two spaced-apart surfaces, the first surface including a portion that receives a high-pressure water source, and the second surface including a portion that engages a receiving surface of an abrasive water-jet nozzle, a jewel having a water-jet forming orifice carried on the receiving portion of the first surface. The assembly also includes a bore, and an air-vent pathway, the bore coupling the orifice and the air-vent pathway. The air-vent pathway may be proximate to the second surface, and may include a slot.

A still further embodiment of the present invention includes a vented abrasive water-jet nozzle. The nozzle includes a body having an abrasive-material mixing cavity, a water-jet forming orifice, and a airflow restriction orifice between the orifice and the mixing cavity defining a water-jet pathway. The nozzle also includes an air gap in the water-jet pathway at a location upstream of the mixing cavity, an air-vent inlet port, and an air-vent pathway coupled between the air-inlet port and the air gap.

These and various other features as well as advantages of the present invention will be apparent from a reading of the following detailed description and a review of the associated drawings.

### BRIEF DESCRIPTION OF THE DRAWINGS

The features of the present invention which are believed to be novel are set forth with particularity in the appended claims. The invention, together with further objects and advantages thereof, may best be understood by making reference to the following description taken in conjunction with the accompanying drawings, in the several figures of which like referenced numerals identify like elements, and wherein:

FIG. 1 is a cross-sectional view illustrating an abrasive water-jet cutting head, as is known in the prior art;

FIG. 2 provides a close-up cross-sectional view of the water-jet and abrasive water-jet forming portions of the cutting head of FIG. 1, as is known in the prior art;

FIG. 3 is a cross-section view illustrating a portion of an abrasive water-jet cutting head, according to an embodiment of the invention;

FIG. 4 is a cross-section view illustrating another abrasive waterjet cutting head, according to an embodiment of the invention;

FIG. 5 illustrates additional details of the vented orifice assembly of FIG. 3, according to an embodiment of the invention;

FIG. 6 illustrates another vented orifice assembly, according to an embodiment of the invention; and

FIG. 7 illustrates a further vented orifice assembly, according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims. Referring to the drawings, like numbers indicate like parts throughout the views. Additionally, a reference to the singular includes a reference to the plural unless otherwise stated or inconsistent with the disclosure herein.

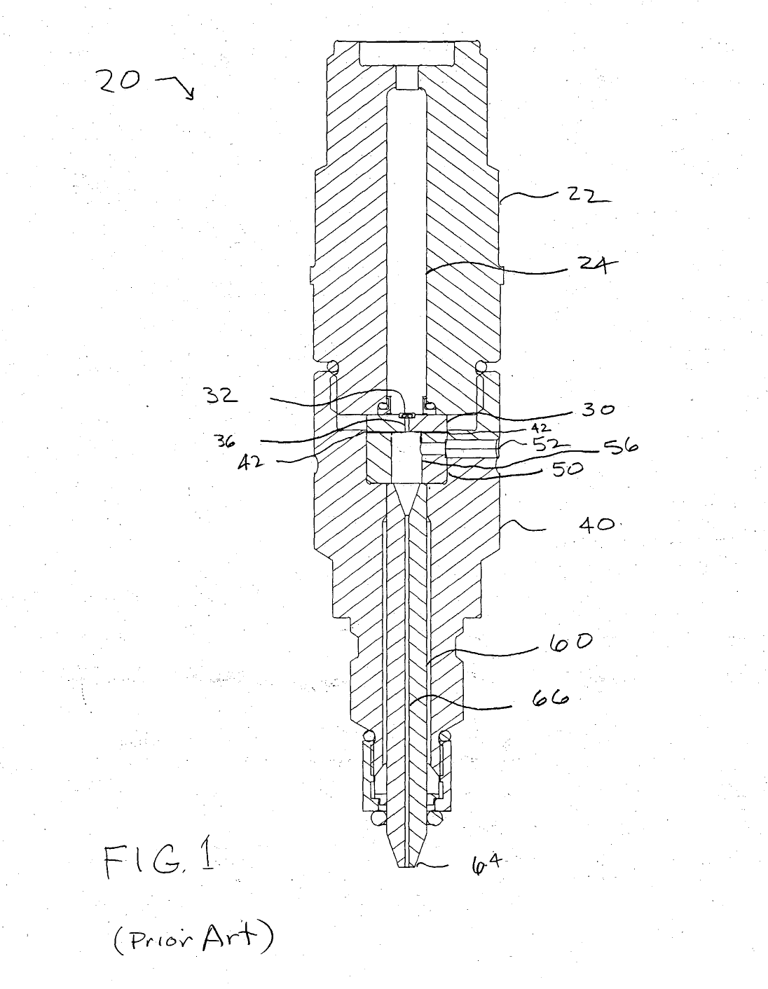

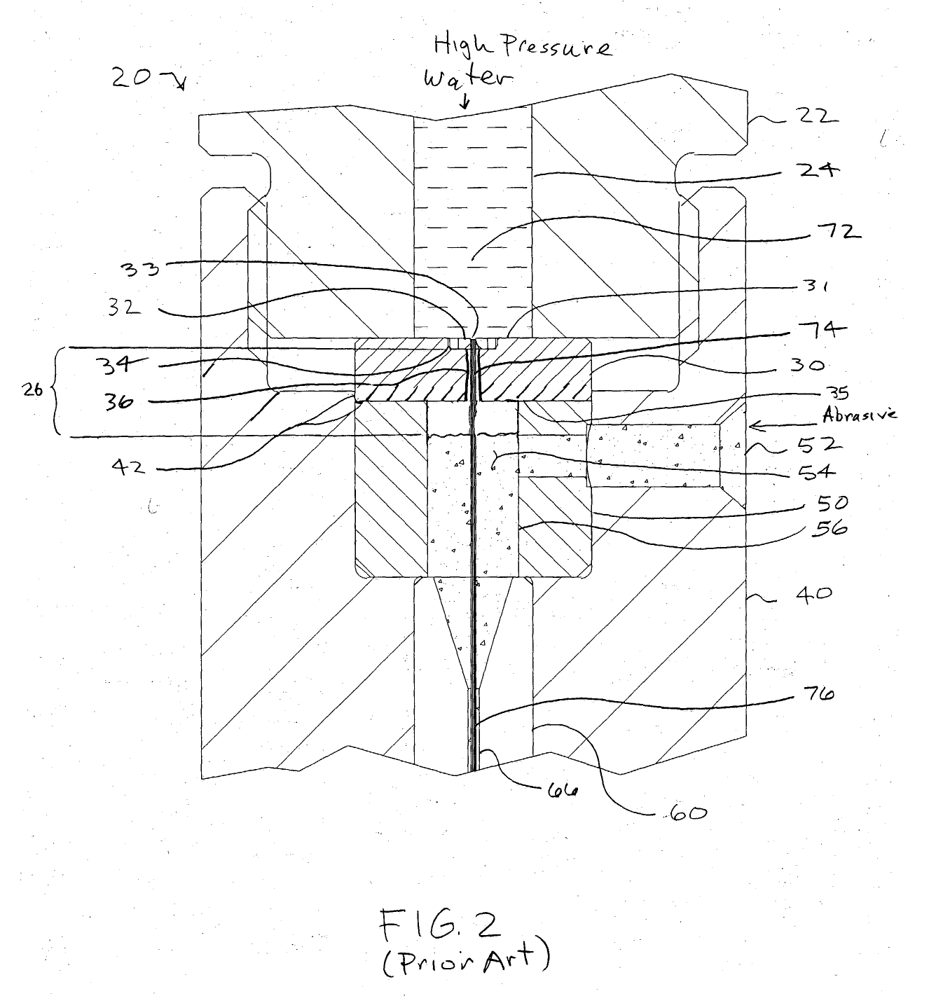

FIGS. 1 and 2 are cross-sectional views illustrating an abrasive water-jet cutting head 20, as is known in the prior art. FIG. 1 provides a view of the entire cutting head 20, and FIG. 2 provides a close-up view of the water-jet and abrasive water-jet forming portions of the cutting head 20. The cutting head 20 includes a high-pressure water inlet body 22 that is removably coupled to a two-stage nozzle body 40. The nozzle body 40 includes an abrasive-material mixing element 50, a mixing tube 60, and an abrasive-material inlet port 52. The abrasive-material mixing element 50 includes an abrasive-material mixing cavity 56, and a receiving surface 42 that receives the orifice assembly 30 for seating and positioning. Another portion of the nozzle body 40 may also contribute to the receiving surface. The mixing tube 60 includes a mixing-tube bore 66 and a nozzle tip 64.

The orifice assembly 30 includes a body having two spaced-apart surfaces, the first surface including a portion 31 configured for receiving water from a high-pressure water source 72, such as provided through inlet water bore 24, and a second surface that includes an engaging portion 35 that engages the receiving surface 42. The orifice assembly 30 also includes a jewel seat 34 defined in the portion 31 that carries a jewel 32 having a water-jet forming orifice 33, and a bore 36 that couples the orifice 33 to the second surface. Typical dimensions for an abrasive water-jet include a diameter of the orifice 33 between approximately 0.010 and 0.014 of an inch, and an inside diameter of the bore 36 between approximately 0.015 and 0.040 of an inch. In a preferred embodiment, an orifice diameter of approximately 0.014 of an inch and a bore 36 diameter of approximately 0.020 of an inch form a good water-jet 74 for abrasive water-jet cutting. The jewel 32 may be ruby, sapphire or diamond, with sapphire being the most common. Diamond jewels are recognized to last the longest, but ruby and sapphire jewels are preferred because diamond jewels are presently costly. The body of the orifice assembly 30 may be made from any hard, precision machinable and corrosion-resistant material, such as stainless steel. The jewel 32 is precisely mounted to the orifice assembly 30. The orifice assembly 30 is configured to be received into a precisely machined receiving surface 42 of the nozzle body 40. The orifice assembly bore 36 defines a portion of a water-jet pathway 26 between the jewel 32 and the mixing cavity 56.

The abrasive-material mixing element 50 is typically made of a hard material, such as a tungsten carbide. The abrasive-material mixing element 50, particularly the mixing cavity 56, is an area that is subject to wear. This wear is caused by the erosive action of the stream of abrasive material 54 as it enters the side of the mixing cavity 56 and is entrained by the water-jet 74. A typical mixing tube 60 used in an abrasive water-jet nozzle is between approximately three and four inches long, and has a bore between approximately 0.030 and 0.040 inch. The mixing tube 60 is made from a hard material designed to resist abrasion by the abrasive material, such as a high grade tungsten carbide. The mixing tube 60, the abrasive-material mixing element 50, and the orifice 33 all are subject to wear and have finite lives.

FIG. 2 also illustrates the abrasive water-jet cutting head 20 in use. Abrasive water-jet systems generally use the same basic two-stage nozzle design illustrated in FIG. 2. In the first stage, high-pressure water 72 is supplied through the inlet water bore 24 of the high-pressure water inlet body. The receiving portion 31 of the first surface of the orifice assembly 30 is exposed to and receives the high-pressure water 72, which passes through the waterjet forming orifice 33 carried in the receiving portion 31. The water passing through the orifice 33 forms a water-jet 74, which passes through orifice assembly bore 36 and exits the orifice assembly 30 at its second surface.

The orifice assembly 30 is precisely engaged in the receiving surface 42, and the orifice assembly bore 36 and the mixing tube bore 66 are in coaxial alignment. The water-jet 74 passes from the orifice assembly bore 36 into the abrasive-material mixing cavity 56 of the abrasive-material mixing element 50 to begin the second stage. When the water-jet 74 passes into the mixing cavity 56, a Venturi effect creates a vacuum that pulls abrasive material 54 into the mixing cavity 56 through the abrasive-material inlet port 52 from a feed tube connected to an external abrasive-material supply. Particles of the abrasive material 54 are accelerated by the water-jet 74, and together pass into the long, hollow cylindrical mixing-tube bore 66. The resulting mix of abrasive material 54 and water-jet 74 forms an abrasive water-jet 76 that exits the nozzle tip 64 as a coherent stream and cuts away material of the workpiece.

In theory, the water-jet forming orifice 33 should operate reliably until dissolved solids and minerals in the water build up in or about the orifice 33. However, over time the orifice 33 fails to produce a straight, smooth stream of water primarily because of chipping on its inlet edge by abrasive particles of the abrasive material 54. Abrasive particles from the mixing cavity 56 manage to get upstream to the orifice 33 through the orifice assembly bore 36. The exact mechanism of this upstream travel phenomenon is not known, but it may occur during operation because of the suction created by the Venturi effect drawing abrasive material 54 up the water-jet pathway 26, during waterjet on and off cycles, or during nozzle changes or overhauls. Impact of this abrasive causes the jewel to chip, substantially altering water flow through the orifice 33. Once water flow through the orifice 33 is disturbed, the cut quality will be poor and the mixing-tube life will be shortened dramatically.

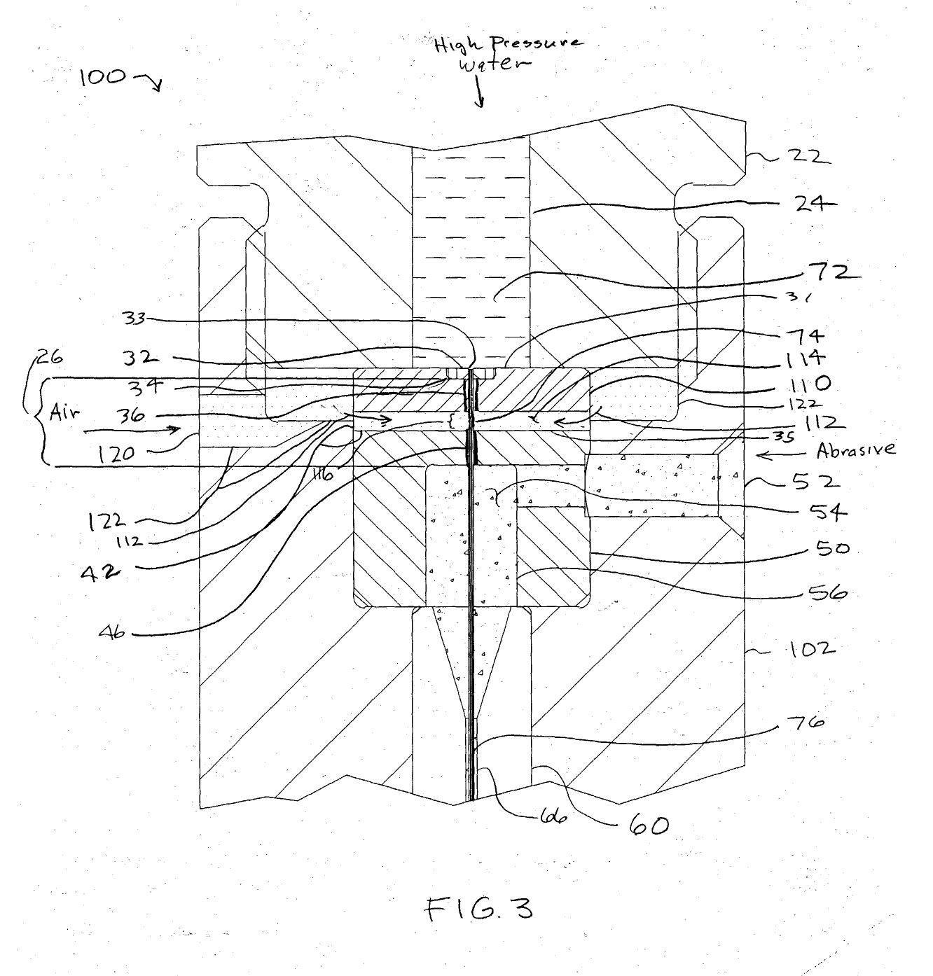

FIG. 3 is a cross-section view illustrating a portion of an abrasive water-jet cutting head 100, according to an embodiment of the invention. The nozzle body 102 portion of the cutting head 100 is substantially similar to the nozzle body 40 of FIGS. 1 and 2, and additionally includes an air-inlet port 120, a nozzle body air-vent chamber 122, and an airflow restriction orifice 46. The vented water-jet forming orifice assembly 110 is substantially similar to the orifice assembly 30 of FIGS. 1 and 2, and additionally includes a slot 114 defining an air-vent pathway 112. The entire air-vent pathway begins at the inlet port 120, flows intermediately through nozzle body air-vent chamber 122, and ends in the airflow restriction orifice 46. The air-vent pathway 112 describes only a portion of the air-vent pathway within or proximate to the mixing element 50. Aspects of the invention includes ventilating the water-jet 74 at a point in the water-jet pathway 26 between its formation at the orifice 33 and entry into the mixing cavity 56.

The nozzle body 102 of FIG. 3 includes the air-inlet port 120 and the nozzle body air-vent chamber 122 that couples ambient air to the vented orifice assembly 110. The vented orifice assembly 110 includes an orifice assembly air-vent pathway 112 coupling the air-vent chamber 122 with the water-jet pathway 26. In the embodiment illustrated in FIG. 3, a slot 114 is defined in the second surface of the vented orifice assembly 110 to establish the air-vent pathway 112. The slot 114 is further defined through a portion of the orifice assembly bore 36 proximate to the second surface, defining a slotted air-vent cavity about the water-jet pathway 26. The perspective of FIG. 3 does not clearly show the portion 35 of the second surface of the orifice assembly 110 that engages the receiving surface 42. However, the orifice assembly 110 engages with and is received by the receiving surface 42 in substantially the same manner as described in conjunction with FIGS. 1 and 2. When the orifice assembly 110 is received in the nozzle body 102, an air gap 116 will be defined proximate to the water-jet pathway 26 providing an air-vent pathway that vents a portion of the water-jet pathway between the orifice 33 and the mixing cavity 56.

An aspect of the invention includes ventilating the water-jet pathway 26 with ambient air at substantially ambient pressure (“ambient air”) along at least a portion of the waterjet pathway when the orifice assembly 110 is received in the nozzle body 102. An air-vent pathway begins at the inlet port 120, flows intermediately through nozzle body air-vent chamber 122 and the orifice assembly air-vent pathway 112, and finally into the air gap 116 and the airflow restriction orifice 46. In operation, ambient air flowing through the air-vent pathway ventilates and reduces vacuum along a portion of the water-jet pathway 26, including the air gap 116 and the orifice 46. The airflow restriction orifice 46 limits ventilation of the mixing cavity 56 and any corresponding reduction of vacuum in the cavity. As discussed in more detail below, the cross-section area of the air-vent pathway along its entire length, particularly at the air-vent pathway 112, should be large enough to provide ambient air to the air gap 116 and airflow restriction orifice 46 in sufficient volume and pressure to inhibit the upstream abrasive particle migration phenomenon.

Previous unsuccessful attempts to inhibit the upstream abrasive particle migration phenomenon assumed that only a small volume of ambient air was necessary to vent a water-jet pathway, such as the water-jet pathway 26. A previous unsuccessful attempt included an air-vent pathway having a cross-section area less than twenty percent larger than the cross-section area of the water-jet pathway. The previous attempt employed two air-vent pathways flowing into the water-jet pathway from opposite directions, each having a diameter of 0.047 inch. The water-jet pathway of the unsuccessful attempt, similar to that presently defined by restriction orifice 46, had a diameter of approximately 0.062 inch. The cross-section area of the water-jet pathway and the combined cross-section area of the two air-vent pathways were approximately equal (within twenty percent) in the unsuccessful attempt.

Experiments conducted in conjunction with embodiments of the invention discussed in these specifications demonstrated that providing ambient air at the air gap 116 with sufficient pressure and volume inhibits abrasive particles from migrating upstream and damaging the jewel mount, the orifice walls in the jewel, and other surfaces of the orifice. Typically, the cross-section area of a passage is a significant variable in determining how much air can flow through a passage. Increasing a cross-section area of the air-vent pathway increases airflow and decreases pressure drop. A larger cross-section of the air-vent pathway is generally better, particularly the portion proximate to the air gap 116. For example, abrasive particle migration is significantly reduced when a ratio of the minimum cross-section area of the orifice assembly air-vent pathway to the minimum cross-section area of the airflow restriction orifice 46 is two. A ratio of about four effectively eliminates abrasive material damage to the water-jet forming jewel orifice 33. The physical structure of the nozzle body 102 allows the nozzle air-vent chamber 122 and the air-inlet port 120 to both typically have cross-section areas many times larger than the cross-sectional area of the airflow restriction orifice 46. An aspect of the invention includes forming the slot 114 such that the cross-section area of pathways 112 providing ambient airflow into the gap 116 is at least twice the cross-section area of the orifice 46, and preferably more than four times the cross-section area. The above ratios are intended to be a method of describing an ability of an air-vent passageway structure to provide sufficient ambient air to the water-jet pathway, and are not intended to be a strict rule. In some alternative configurations of air-vent passageway structures, it may be difficult to precisely compute a minimum cross-section area of the air-vent passageway. In such event, an equivalent cross-section area may be developed with reference to appropriate factors representing a capacity of the alternative air-vent passageway structure to deliver ambient air to the air gap 116 and the restriction orifice 46 in volume and pressure equivalent to more readily calculatable structures.

In use, the abrasive water-jet cutting head 100 operates in the same manner as the non-vented abrasive water-jet head 20 of FIGS. 1 and 2, except that ambient air is available to the nozzle body 102 through air-inlet port 120. An embodiment of the invention illustrated in FIG. 3 and discussed in these specifications was built and tested. The built embodiment used a diameter of approximately 0.020 inch for the air-restriction orifice 46, a diameter of approximately 0.014 inch for the waterjet forming jewel orifice 33, and a cross-section area of the slot 114 forming the orifice assembly air-vent pathway 112 that was a total of about four times the cross-section area of the restriction orifice 46. The embodiment was tested for migration of abrasive material 54 upstream into the vicinity of the jewel 32 and the waterjet forming orifice 33. No significant migration was found during the testing. When the air-inlet port 120 was blocked in further testing, abrasive material 54 was found in the water-jet pathway 26 and on the receiving portion 31 of the of the orifice assembly 110, evidencing upstream migration above the orifice 33 typical for the non-vented abrasive water-jet cutting head 20 of FIGS. 1 and 2.

While ventilation is described herein using ambient air, a gas from any source with suitable characteristics may be used to ventilate the water-jet 74. If the abrasive material was fed to the water-jet cutting head 100 from a source pressurized above ambient pressure, the cross-section area of the air-vent pathway may require modification to provide sufficient air to the air gap 116 to minimize the upstream abrasive particle migration phenomenon. Alternatively, pressurized air could be provided to the inlet 120 to increase volume and pressure of air available at air gap 116 and orifice 46. If the pressure is high enough, the cross-section area of the air-vent pathway could be relatively small.

In a further alternative embodiment, an orifice assembly may be one piece of hard material, such as a ceramic. The water-jet forming orifice 33 and orifice assembly bore 36 could be formed by a single hole through the orifice assembly if the water-jet pathway length in the orifice assembly was less than approximately five orifice diameters. For water-jet pathway lengths in a one-piece orifice assembly having a length of five orifice diameters or more, the orifice assembly bore 36 should be larger than the orifice to limit interference between the water-jet and the wall of the bore.

FIG. 4 is a cross-section view illustrating a portion of an abrasive water-jet cutting head 140, according to an embodiment of the invention. The nozzle body 142 is substantially similar to the nozzle body 102 of FIG. 3. However, an air-vent pathway is provided entirely within the nozzle body 142, thus, allowing use of a non-vented type orifice assembly, such as the orifice assembly 30, rather than requiring an orifice assembly having an air-vent pathway, such as the orifice assembly 110. The nozzle body 142 includes a nozzle body air-vent chamber 148, and abrasive-material mixing element air-vent pathway 144.

The air-vent chamber 148 is substantially similar to the air-vent chamber 122 of nozzle body 102, except that it is configured to vent using a pathway defined within the abrasive-material mixing element 50 rather than within an orifice assembly. The mixing chamber air-vent pathway 144 is defined in the abrasive-material mixing element 50, and may be a slot cut in the receiving surface 42 and in air communication with the air-vent chamber 148. When the orifice assembly 30 is received in the nozzle body 142, an air gap 116 will be defined ventilating the water-jet pathway 26 between the orifice 33 and the mixing cavity 56.

In a less preferred alternative embodiment, an enclosed air-vent pathway may be defined wholly within the structure of the abrasive-material mixing element 50 without requiring that an orifice assembly be mounted to the receiving surface 42 to complete enclosure of the air-vent pathway. In such an alternative embodiment, the enclosed air-vent pathway may be defined wholly within the element 50 by a passage between air-vent chamber 148 and the airflow restriction orifice 46, for example, by drilling a hole into the airflow restriction orifice 46 to form an air gap. This embodiment is less preferred because of difficulty in cleaning an air gap formed wholly within a structure.

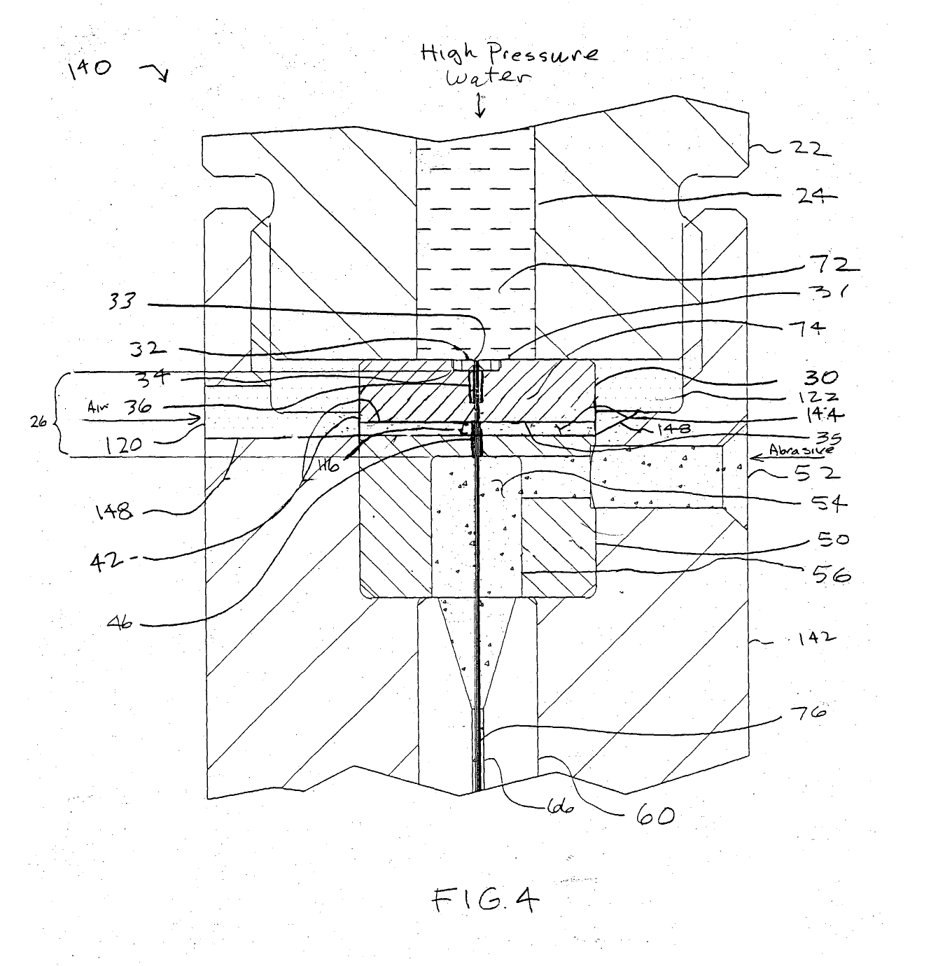

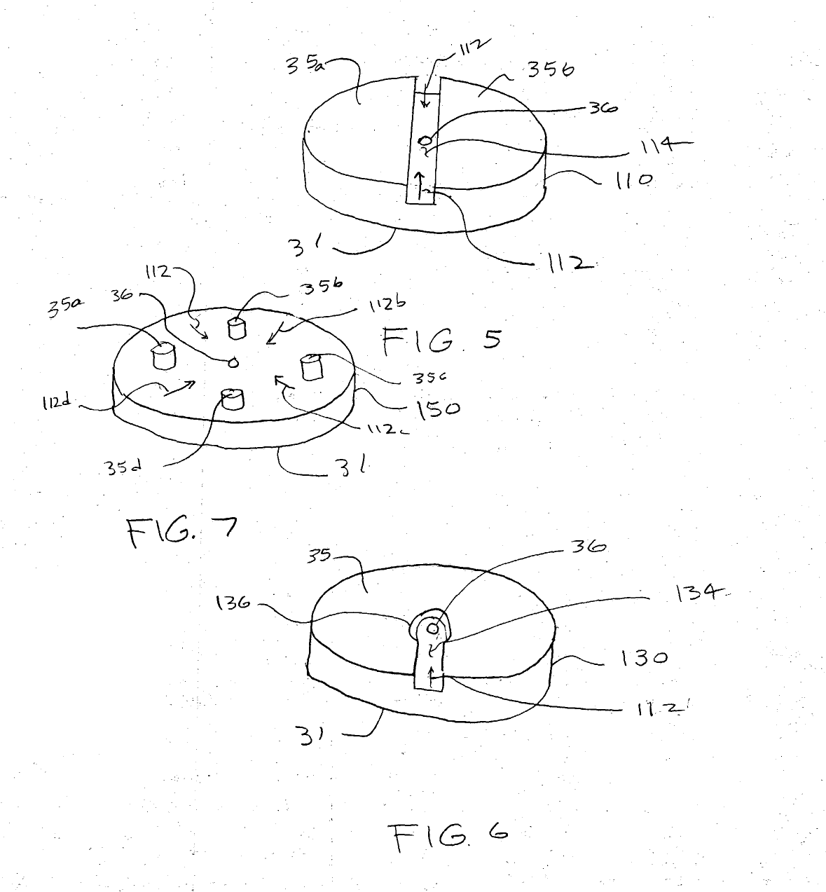

FIGS. 5-7 are perspective views of alternative embodiments of vented orifice assemblies, according to an embodiment of the invention. The second surface and its engaging portion 35 are orientated upward on FIGS. 5-7 for a better perspective of the air-vent pathway 112, rather than downward as in the prior figures. The vented orifice assemblies are similar to the orifice assembly 30 of FIGS. 1 and 2, except that one or more air-vent pathways 112 are provided between at least one portion of a peripheral surface of the orifice assembly and the water-jet pathway 26.

FIG. 5 illustrates additional details of the vented orifice assembly 110 of FIG. 3, according to an embodiment of the invention. The body of the orifice assembly 110 includes a cylindrical member with two spaced apart, approximately parallel surfaces and having a round cross-section. As described in conjunction with FIGS. 1 and 2, the jewel 32 having the water-jet forming orifice 33 is carried on the first surface (not shown), and the second surface includes portions 35a and 35b that engage the receiving surface 42 of a nozzle body. A portion of a side of the vented orifice assembly 110 may also be configured to engage the receiving surface 42 to aid in precisely positioning the orifice assembly 110 in a nozzle body, such as the nozzle body 102 of FIG. 3. The orifice assembly bore 36 couples the orifice 33 and the second surface.

The air-vent pathway 112 and the engaging portions 35a and 35b may be defined by a slot 114 cut in the second surface of the orifice assembly 110. The slot 114 may have any cross-section configuration suitable for the air-vent pathway 112, including a rectangular or a round cross-section. The slot may be defined by cutting or removing material from the body of the vented orifice assembly 110. The slot 114 is defined such that a portion intersects the orifice assembly bore 36 and opposing sides of the body of the orifice assembly 110 as illustrated in FIG. 5. The slot 114 defines the air-vent pathway 112 between a periphery of the vented orifice assembly 110 and the water-jet pathway 26 as established by the bore 36. Alternatively, a plurality of slots 114 may be defined, with one or more of the slots coupling with the water-jet pathway 26. In further alternative embodiment, the vented orifice assembly 110 may be defined on a cylindrical body by mounting the engaging portions 35a and 35b to the second surface in a manner that defines the slot 114. The air-vent pathway 112 includes a configuration allowing passage of air along its surface such that, when the vented orifice assembly 110 is received into the nozzle body 102 of FIG. 3, sufficient access is provided to the water-jet pathway 26 by ambient air to inhibit upstream migration of abrasive particles.

An embodiment of vented orifice assembly 110 was built and successfully tested as described in conjunction with the nozzle body 102 of FIG. 3. The vented orifice assembly 110 was built with a stainless steel, cylindrical body having a diameter of approximately ⅝-inch and a thickness of approximately 3/16-inch. The slot 114 had a width of approximately 1/16-inch across the second surface, and a depth of approximately 1/32-inch.

In a less preferred alternative embodiment, an enclosed air-vent pathway may be defined wholly within the body of the orifice assembly 110, thus, not requiring that an orifice assembly be mounted to the receiving surface 42 to complete enclosure of the air-vent pathway. In such an alternative embodiment, the enclosed air-vent pathway may be defined wholly within the orifice assembly 110 by a passage between a peripheral portion of the orifice assembly 110 and the bore 36, for example, by drilling a hole.

FIG. 6 illustrates a vented orifice assembly 130, according to an embodiment of the invention. The vented orifice assembly 130 is similar to vented orifice assembly 110, except that the slot 134 is defined between only one peripheral surface of the assembly 110 and the bore 36, and includes a widened portion 136 having a partially cylindrical shape about the bore 36.

FIG. 7 illustrates a vented orifice assembly 150, according to an embodiment of the invention. The vented orifice assembly 150 is similar to vented orifice assembly 110, except that the air-vent pathway 112 is defined by a plurality of engaging portions 35a-35d, thus forming a plurality of air-vent sub-passageways 112a-112d. As with the vented orifice assembly 110, the plurality of engaging portions 35a-35d may be defined by removing or cutting away portions of the second surface, or by mounting the plurality of engaging portions 35a-35d on the second surface.

Although the present invention has been described in considerable detail with reference to certain preferred embodiments, other embodiments are possible. Therefore, the spirit or scope of the appended claims should not be limited to the description of the embodiments contained herein. It is intended that the invention resides in the claims hereinafter appended.

1. A vented abrasive waterjet nozzle, comprising:
a body having an abrasive-material mixing cavity, a water-jet forming orifice, and an airflow restriction orifice defining a water-jet pathway and coupling the orifice and the mixing cavity;
an air-vent inlet port; and
an air-vent pathway coupled between the air-inlet port and the water-jet pathway,
the airflow restriction orifice having a first minimum cross-section area and the air-vent pathway having a second minimum cross-section area, the second cross-section area being at least twice the first minimum cross-section area.

2. A vented abrasive water-jet nozzle, comprising:
a body having an abrasive-material mixing cavity, a water-jet forming orifice, and an airflow restriction orifice defining a water-jet pathway and coupling the orifice and the mixing cavity;
an air-vent inlet port; and
an air-vent pathway coupled between the air-inlet port and the water-jet pathway,
the air-vent pathway allowing passage of sufficient air between the air-vent inlet port and the water-jet pathway to inhibit upstream migration of abrasive particles from the mixing cavity.

3. A vented abrasive water-jet nozzle, comprising:
a nozzle body including an abrasive-material mixing cavity, a receiving portion having a receiving surface that receives a water-jet forming orifice assembly, and an airflow restriction orifice coupling the receiving portion and the abrasive-material mixing cavity and defining a water-jet pathway;
an air-vent inlet port; and
an air-vent pathway coupled between the air-inlet port and the water-jet pathway,
the airflow restriction orifice having a first minimum cross-section area and the air-vent pathway having a second minimum cross-section area, the second minimum cross-section area being at least twice the first minimum cross-section area.

4. The nozzle of claim 3, wherein the water-jet pathway further includes an orifice assembly bore of the orifice assembly when the orifice assembly is received in the nozzle body.

5. The nozzle of claim 4, wherein the water-jet pathway further includes an air gap between the orifice assembly bore and the airflow restriction orifice.

6. The nozzle of claim 5, wherein the air-vent pathway is further coupled between the air-inlet port and the air gap.

7. The nozzle of claim 5, wherein the air gap is defined when the orifice assembly is received in the nozzle body, where the orifice assembly includes the air gap in the water-jet pathway.

8. The nozzle of claim 4, wherein the orifice assembly includes an orifice assembly air-vent pathway, and the air-vent pathway includes the orifice assembly air-vent pathway.

9. The nozzle of claim 3, wherein the water-jet pathway includes an air gap in the airflow restriction orifice, and the air-vent pathway is further coupled between the air-inlet port and the air gap.

10. The nozzle of claim 3, wherein the air-vent inlet port is configured for venting with an ambient atmosphere.

11. The nozzle of claim 3, wherein the second minimum cross-section area is at least four times the first minimum cross-section area.

12. A vented abrasive water-jet nozzle, comprising:
a nozzle body including an abrasive-material mixing cavity, a receiving portion having a receiving surface that receives a water-jet forming orifice assembly, and an airflow restriction orifice coupling the receiving portion and the abrasive-material mixing cavity and defining a water-jet pathway;
an air-vent inlet port; and
an air-vent pathway coupled between the air-inlet port and the water-jet pathway,
the air-vent pathway allowing passage of sufficient air between the air-vent inlet port and the water-jet pathway to inhibit upstream migration of abrasive particles from the mixing cavity.

13. A vented water-jet forming assembly, comprising:
a body including a portion that engages a receiving surface of an abrasive waterjet nozzle, a water-jet forming orifice, and a bore having a first minimum cross-section area; and
an air-vent pathway having a second minimum cross-section area that is at least twice the first minimum cross-section area, the bore coupling the orifice and the air-vent pathway.

14. The assembly of claim 13, wherein the water-jet forming orifice comprises a hole in a jewel.

15. The assembly of claim 13, wherein the body includes two spaced-apart surfaces, the orifice being defined in one surface and the engaging portion being defined in another surface.

16. The assembly of claim 13 wherein the air-vent pathway includes a slot in the another surface.

17. The assembly of claim 16, where the slot defines a cavity about the bore.

18. The assembly of claim 13, wherein the assembly, when engaged with a receiving surface of an abrasive water-jet nozzle body, cooperatively defines with the nozzle body an air-vent pathway between an air-inlet port of the nozzle and a water-jet pathway.

19. The assembly of claim 13, wherein the assembly, when engaged with a receiving surface of an abrasive water-jet nozzle, cooperatively defines an air gap between the orifice assembly bore and an airflow restriction orifice of the nozzle, the air gap being in air communication with the air-vent pathway.

20. The assembly of claim 13, wherein the orifice has an inside diameter between approximately 0.010 and approximately 0.020 inch.

21. The assembly of claim 13, wherein the bore has an inside diameter between approximately 0.015 and approximately 0.040 inch.

22. The assembly of claim 13, wherein the second cross-section area is at least four times the first cross-section area.

23. A vented water-jet forming assembly, comprising:
a body including a portion that engages a receiving surface of an abrasive water-jet nozzle, a water-jet forming orifice, and a bore; and
an air-vent pathway allowing passage of sufficient air along its surface, such that, when the body is received in the abrasive water-jet nozzle, sufficient access by ambient air is provided to a water-jet pathway of the nozzle to inhibit upstream migration of abrasive particles,
the bore coupling the orifice and the air-vent pathway.

24. A vented water-jet forming assembly comprising:
a body including two spaced-apart surfaces, the first surface including a portion that receives a high-pressure water source, and the second surface including a portion that engages a receiving surface of an abrasive water-jet nozzle, a jewel having a water-jet forming orifice, the jewel mounted on the receiving portion of the first surface, and a bore having a first minimum cross-section area; and
an air-vent pathway having a second minimum cross-section area that is at least twice the first minimum cross-section area,
the bore coupling the orifice and the air-vent pathway.

25. The assembly of claim 24, where the air-vent pathway is proximate to the second surface.

26. The assembly of claim 24, where the air-vent pathway includes a slot.

27. A vented water-jet forming assembly comprising:
a body including two spaced-apart surfaces, the first surface including a portion that receives a high-pressure water source, and the second surface including a portion that engages a receiving surface of an abrasive water-jet nozzle, a jewel having a water-jet forming orifice, the jewel mounted on the receiving portion of the first surface, and a bore; and
an air-vent pathway allowing passage of sufficient air along its surface, such that, when the body is received in the abrasive water-jet nozzle, sufficient access by ambient air is provided to a water-jet pathway of the nozzle to inhibit upstream migration of abrasive particles,
the bore coupling the orifice and the air-vent pathway.

28. A vented abrasive water-jet nozzle, the nozzle comprising:
means for passing a water-jet between a water-jet forming orifice and an abrasive-material mixing cavity; and
within the passing means, a means for venting the water-jet, the, passing means having a first minimum cross-section area and the venting means having a second minimum cross-section area, the second minimum cross-section area being at least twice the first minimum cross-section area.

29. The nozzle of claim 27, wherein the venting means is coupled to ambient air.

30. A vented water-jet orifice assembly, the assembly comprising:
means for creating a water-jet from high-pressure water;
means for mixing abrasive material and the water-jet;
means for passing the water-jet between the abrasive material mixing means and the creating means; and
means for allowing passage of sufficient ambient air into the passing means to inhibit migration of abrasive particles proximate to the creating means.
